(19) United States
(12) Patent Application Publication
(10) Pub. No.: US 2015/0295852 A1
(43) Pub. Date: Oct. 15, 2015

(54) PROTECTING AND TRACKING NETWORK STATE UPDATES IN SOFTWARE-DEFINED NETWORKS FROM SIDE-CHANNEL ACCESS

(71) Applicant: NTT INNOVATION INSTITUTE, INC., East Palo Alto, CA (US)

(72) Inventor: Sriram Natarajan, Sunnyvale, CA (US)

(73) Assignee: NTT INNOVATION INSTITUTE, INC., East Palo Alto, CA (US)

(21) Appl. No.: 14/253,513

(22) Filed: Apr. 15, 2014

(51) Int. Cl. H04L 12/927

(52) U.S. Cl. CPC H04L 47/80

(57) ABSTRACT

A system and method of access control and tracking capabilities of programmable switches are described. A system and associated method include an access controller component and a tracker component. The access controller component defines access control rights for a user in a flow of a programmable switch in a network. The access control rights are determined by access control table information and an associated bit-array based flow-level role data structure built by a controller network operator. The tracker component authorizes and permits the user to modify the flow according to a flow modification request, which is based upon information in the access control table information and the associated bit-array based flow-level role data structure for the user. A notification component of a programmable switch notifies the controller of the network about the modification request to the flow.

### BACKGROUND

1. Field

The disclosure herein generally relates to systems and methods for software-defined networks. In particular, systems and methods for protecting and tracking network state updates in a software-defined network from side-channel access are described.

2. Description of the Related Art

In a software-defined network (SDN) architecture, the control and data planes are decoupled, the network intelligence and state are logically centralized, and the underlying network infrastructure is set apart from the applications. As a result, enterprises and carriers can obtain programmability, automation, and network control. This enables them to build highly scalable, flexible networks that can readily adapt to changing business needs. A communication channel operates between the control and data planes of supported network devices.

With reference to FIG. 1, a SDN architecture may comprise a controller component 110, which is a logically centralized control component. The controller component 110 has one or more applications 120 interfacing with it. The SDN also has infrastructure components 130, comprising an array of programmable switches and routers 135. The infrastructure component 130 is also referred to as a data component or an array of forwarding devices. A SDN provides the architectural support to program forwarding devices from a logically centralized, remote control plane, i.e. controller. A SDN also comprises a communication channel 140 between the controller component 110 and the infrastructure component 130. The communication channel 140 is used to communicate bi-directional network state changes between the infrastructure component 130 and the controller component 110. Thus, the communication channel 140 acts as a programmatic interface to exchange network state updates and gather network statistics.

The communication channel 140 implements a protocol on both sides of the interface between the infrastructure component 130 and the controller component 110. An embodiment of a protocol is the OpenFlow protocol. However, other protocols can be implemented within the communication channel 140, such as the Forces Protocol (Forwarding and Control Element Separation Protocol) and the Secure Shell (SSH) Protocol. The protocol provides configuration and interoperability testing between network devices and control software from different vendors. The protocol integrates an enterprise or carrier's existing infrastructure and provides a simple migration path for those segments of the network that need SDN functionality. In an embodiment, the communication channel 140 is the Transmission Control Protocol (TCP), and the OpenFlow protocol runs on top of TCP. If SSH is used, then this also runs on top of TCP. However, other embodiments of the communication channel 140 are contemplated by embodiments of the invention.

The network state in each of the forwarding devices of the infrastructure component 130 is maintained in a flow table, such as the flow table 150 illustrated in FIG. 1. The flow table 150 consists of a set of flow entries that determines how each incoming packet should be handled. Each flow entry consists of a combination of network state information. For the flow table 150 illustrated in FIG. 1, the match field contains header information in each packet that is matched against the set of flow entries. The instructions field determines the set of actions to be applied for each packet. Examples of an instruction field comprise an instruction for an output to an egress port, or to drop the packet. The priority field is used in determining the matching precedence, since a single packet can match multiple flow entries.

The counter field updates the counter information for associated counters for every packet that matches a particular flow. In the timeouts field, flows are evicted from the flow table, either by a control message update from the controller or by the flow expiry mechanism. Timeouts are used to determine when a flow is removed from the flow table. The cookie field contains additional information used by the controller to filter flow based information. The flow table 150 illustrated in FIG. 1 is just one example of a network state; embodiments of the invention are not limited to this illustrated network state. Numerous other fields and combinations of fields are contemplated by embodiments of the invention.

SDNs provide the architectural support to separate the control plane and data plane entities in different physical devices. Several applications compute the network state on top of the control plane and push forwarding entries into the data plane. The network operator and higher layer entities on top of the applications determine the network state by gathering the forwarding entry statistics from the switches in the data plane. However, certain short-comings or weaknesses can result.

Certain entities, such as a network administrator can login to a programmable switch directly and update the flow table state. This is referred to as a side-channel access because the controller plane is being diverted and/or not notified of the update to the flow table state. A side-channel access can be implemented via a Secure Shell protocol (SSH), as an example. An updated flow table state can include creating a new flow, reading the current flow table state, updating an existing flow, or deleting a flow (CRUD).

A side-channel access to update a flow table state can create security issues or misconfigurations. Using a side-channel access, authorized users can login to the forwarding device with required credentials. However, that user may not have access rights to modify the flows in the flow table state. Current mechanisms in programmable switches do not have any control to deny updating a particular flow. If no access right is defined, secure flows, such as a Firewall can be updated without any protections. Authorized users can also introduce misconfigurations, such as a faulty update to a certain security flow. When such an update occurs, the controller plane is oblivious of the change. Such updates could bring the switch state down.

In addition to the security issues and misconfigurations described above, current programmable switches do not provide complete tracking or notification features when any updates are made to the flow table state via a side-channel access. In some programmable interfaces, such as OpenFlow protocol, only flow remove actions are tracked. This is supported only when the controller plane sets a flag during the flow creation process to be notified of a flow remove event. If the controller plane doesn't set the flag, the controller plane is not notified of the update. Information about existing flows can be obtained by periodically sending a statistics request from the controller plane to a switch in the data plane. However, the controller plane may not be aware of new changes, such as a creation, update, or deletion made to the flow table, and therefore, may not request a statistics report.

FIG. 2 is an illustration of a SDN 200, which exemplifies some of the above-described limitations. A controller plane 210 has one or more applications 220 interfacing with it, such as a security application. An infrastructure component 230 comprises an array of programmable switches and routers 235. The infrastructure component 230 is also referred to as a data component or an array of forwarding devices. The SDN 200 comprises a communication channel 240 between the controller component 210 and the infrastructure component 230. FIG. 2 also illustrates a side channel access 250 made to one of the switches 235, via SSH for example, by an authenticated user to update a flow. There is no mechanism in the switch 235 to deny such a flow-level update, since there is no access control mechanism in the flow level. In addition, the controller plane 210 is not notified of such side-channel access updates. Therefore, the network operator view 260 of the controller plane 210 will not match the flow table of the affected switch 235. This can lead to faulty updates, misconfigurations, and security violations.

### SUMMARY

According to an embodiment, a system includes an access controller component and a tracker component. The access controller component stores access control rights of a user to perform an action on a flow table of a programmable switch in a network, wherein the access control rights are determined by stored information that includes a predetermination association of a particular user and a permitted action that that the particular user is allowed to take with respect to the flow table. The tracker component permits the user to perform an action on the flow table according to a flow modification request received at the programmable switch, based upon the stored access control rights.

According to another embodiment, a method is implemented by a system in a network. The method includes receiving an indication of a flow modification request that is received at a programmable switch of the network; and determining whether a user is authorized and permitted to perform an action on a flow table of the programmable switch that is indicated in the flow modification request, based upon access control rights of a user to perform an action on a flow table of the programmable switch, wherein the access control rights are determined by stored information that includes a predetermination association of a particular user and a permitted action that that the particular user is allowed to take with respect to the flow table.

According to another embodiment, a non-transitory computer-readable medium that stores a program is provided, which when implemented by a computer, causes the computer to perform the above-described method.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a conventional software-defined network;

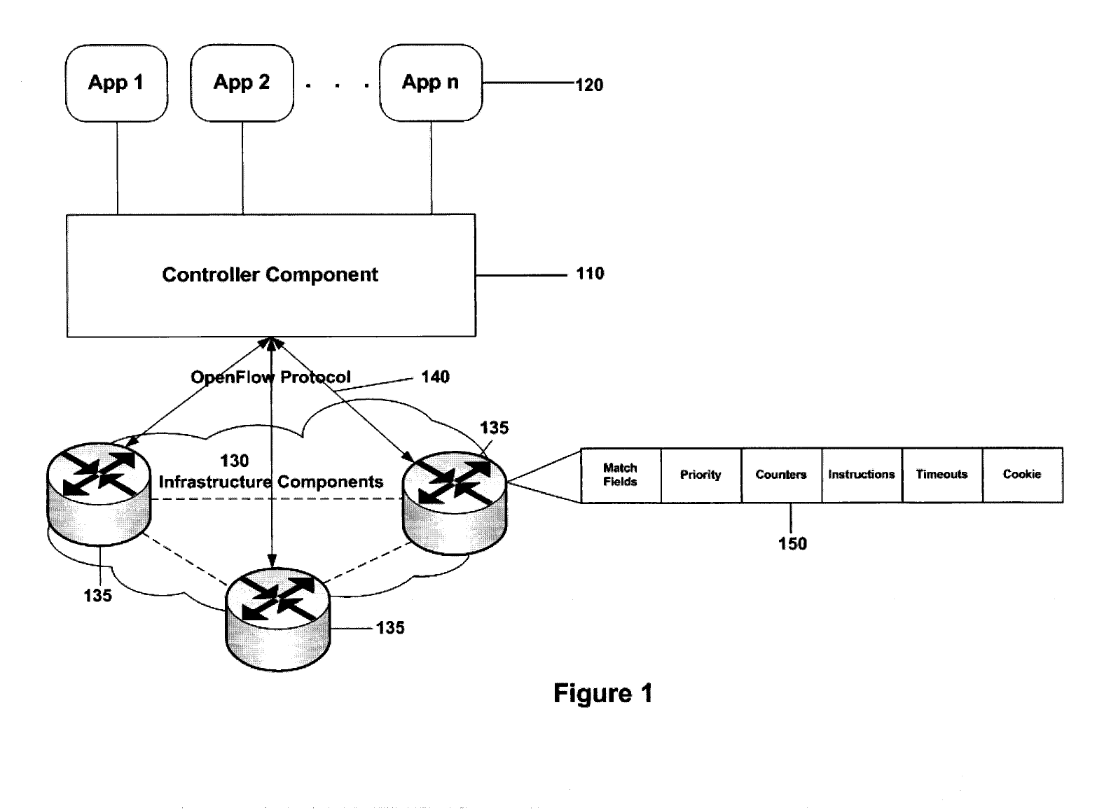

FIG. 2 illustrates various limitations of a conventional software-defined network;

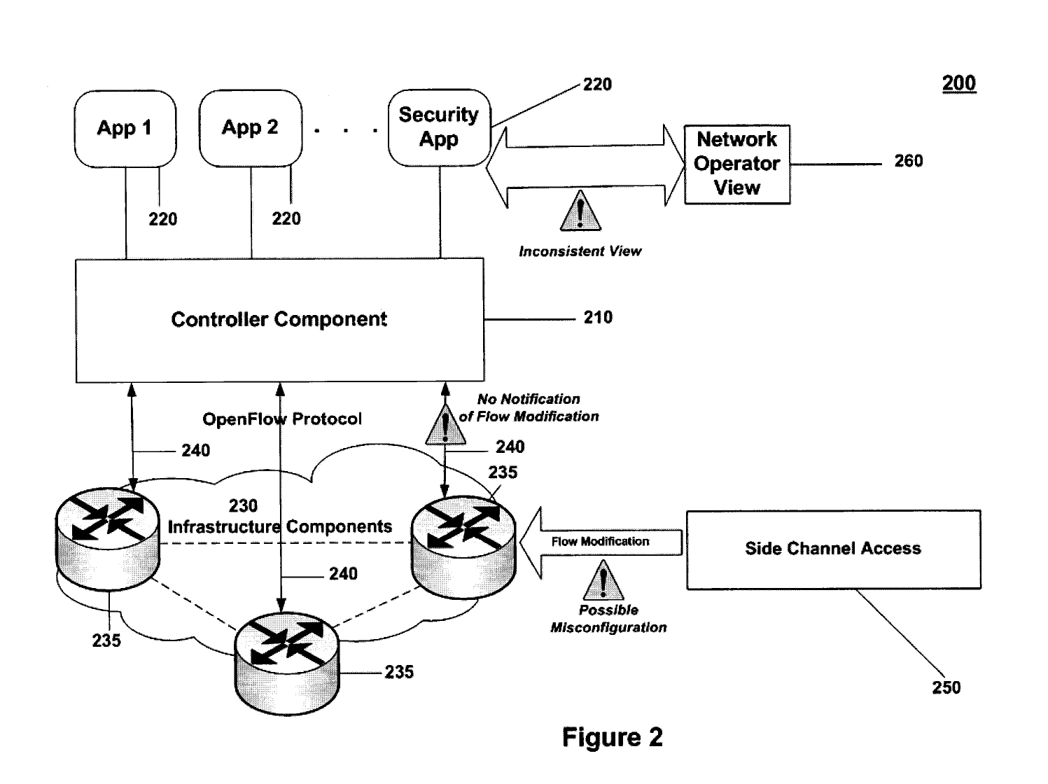

FIG. 3 illustrates a software-defined network with an access and tracking component, according to embodiments described herein;

FIG. 4 is an illustration of an access control table, according to embodiments described herein;

FIG. 5 is a flow chart, according to embodiments described herein;

FIG. 6 is a flow chart, according to embodiments described herein;

FIG. 7 is an illustration of a notification, according to embodiments described herein;

FIGS. 8A and 8B are illustrations of a handshake, according to embodiments described herein;

FIG. 9 is a block diagram of a computing system, according to embodiments described herein; and

FIG. 10 is a flow chart illustrating a method, according to embodiments described herein.

Like reference numerals designate identical or corresponding parts throughout the several views.

### DETAILED DESCRIPTION

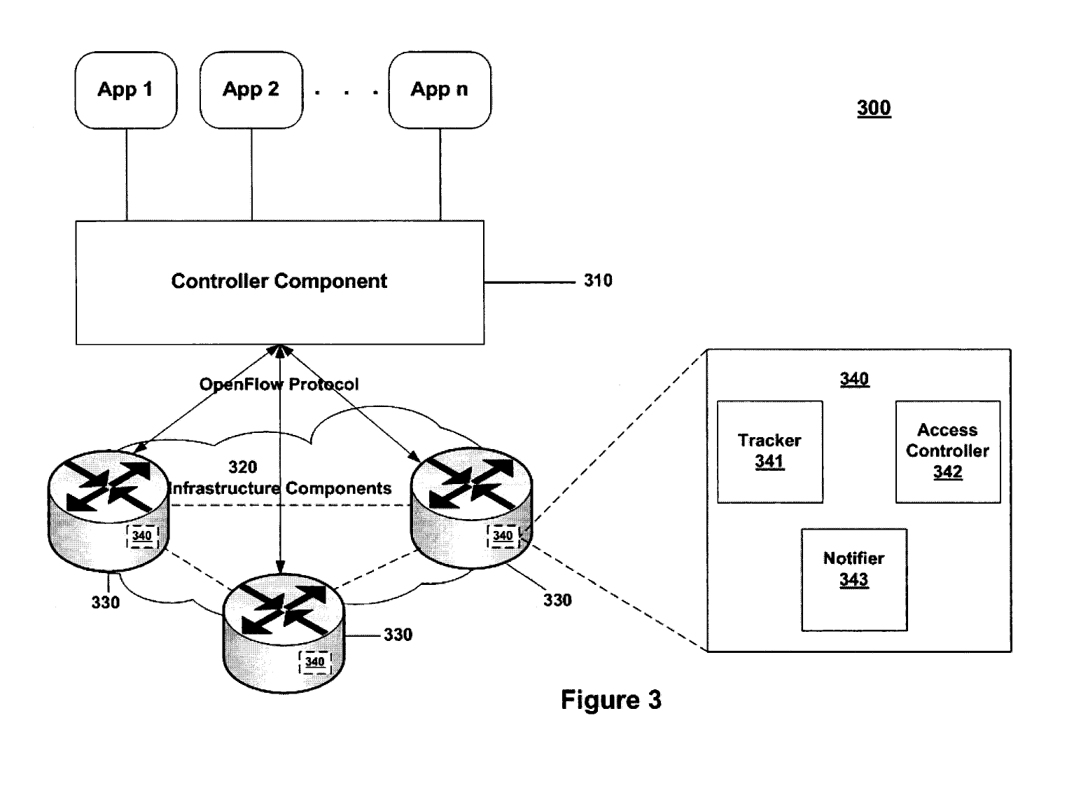

Enabling secure access rights and tracking capabilities of a network state can help prevent erroneous, faulty updates and prevent violations. This is important in a SDN architecture where the control plane and data plane entities are physically separated. FIG. 3 is an illustration of a SDN 300, which contains a controller component 310 (also referred herein as a “main controller” and an infrastructure component 320 with one or more programmable switches 330. The SDN 300 also contains an additional tracking and access control component 340 to access the controller and to track flow updates. The component 340 contains a tracker sub-component 341 and an access controller sub-component 342. The component 340 may also include a notification component (“notifier”) 343, which will be discussed in detail below. The access controller sub-component 342 defines access control rights in each flow for each user. To achieve this, the network operator builds access control table (ACT) information for each flow and its associated bit-array based flow-level role data structure (FRDS).

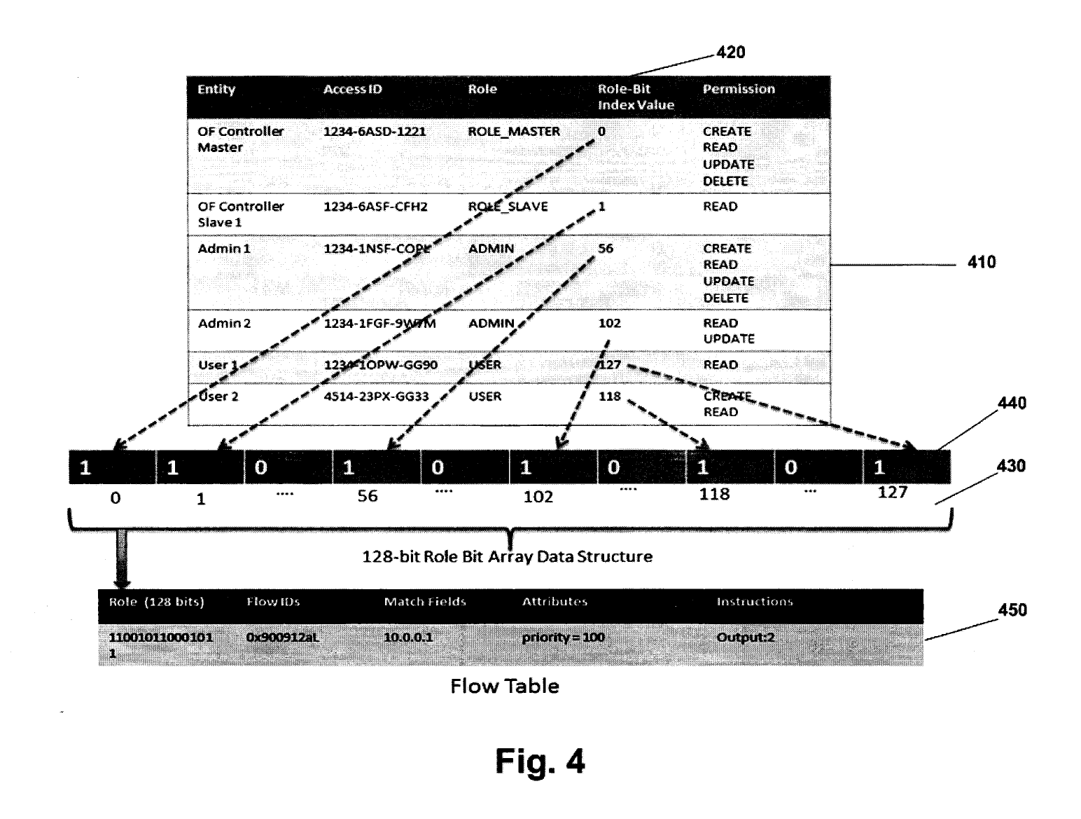

FIG. 4 illustrates an example of an ACT 410 for a particular programmable switch. Six entities are listed, along with their respective access ID numbers, roles, and the permissions associated with each entity. The permission includes one or more flow states of create, read, update, or delete. The ACT 410 is built by the network administrator, who determines and assigns the flow-level roles for the controller entities and for the set of users who will be allowed to login to the associated programmable switch, via SSH and other side-channel mechanisms. Each user or controller is assigned with an access ID number, a unique identifier, and permissions to modify the network state.

FIG. 4 also illustrates a role-bit index value 420 for each user or controller. The role-bit index value 420 is derived from the number of bits available in a bit-array based FRDS. The bit-array based FRDS defines users and their respective roles. In an embodiment, a 128-bit array based FRDS is used. However, other bit sizes are contemplated by embodiments described herein. A 128-bit array based FRDS can support a total of 128 entities to access the flows. The ACT refers to the index value assigned for each user or controller in the FRDS for each flow. FIG. 4 illustrates a partial view of the 128-bit array based FRDS 430, which corresponds to the six illustrated entities. Also illustrated is an associated high or low bit position (on or off) 440 for a particular flow entry. A high bit position of 1 indicates that the entity for the associated role-bit index value has access to modify the flow 450 shown. A low bit position of 0 indicates that the entity for the associated role-bit index value does not have access to modify the flow 450 shown. For example, the FRDS indicates that all six of the illustrated entities have access to modify the flow 450 shown.

An ACT and an associated bit-array based FRDS are located in each programmable switch. Each ACT and associated bit-array based FRDS have a synchronized ACT and associated bit-array based FRDS located in the controller plane. In the SDN 300 illustrated in FIG. 3, each of the three switches 330 have their respective ACT and associated bit-array based FRDS. Four sets of synchronized ACTs and associated bit-array based FRDSs are also located in the controller plane 310. Having an ACT and associated bit-array based FRDS in each programmable switch provides a check point for any side-channel access. In addition, having the synchronized ACT and associated bit-array based FRDS for each programmable switch in the controller plane provides the controller plane with full access and control of any side-channel access.

With reference back to FIG. 3, the component 340 also contains a tracker sub-component 341. The tracker sub-component 341 authorizes and/or permits a user to modify the flow according to a flow modification request when it receives notification that the flow modification request is received at the programmable switch. The authorization and permissions are based upon information in the ACT and the associated bit-array based FRDS for a particular user and flow. When a new flow request is received, the request is sent to the ACT, such as the ACT 410.

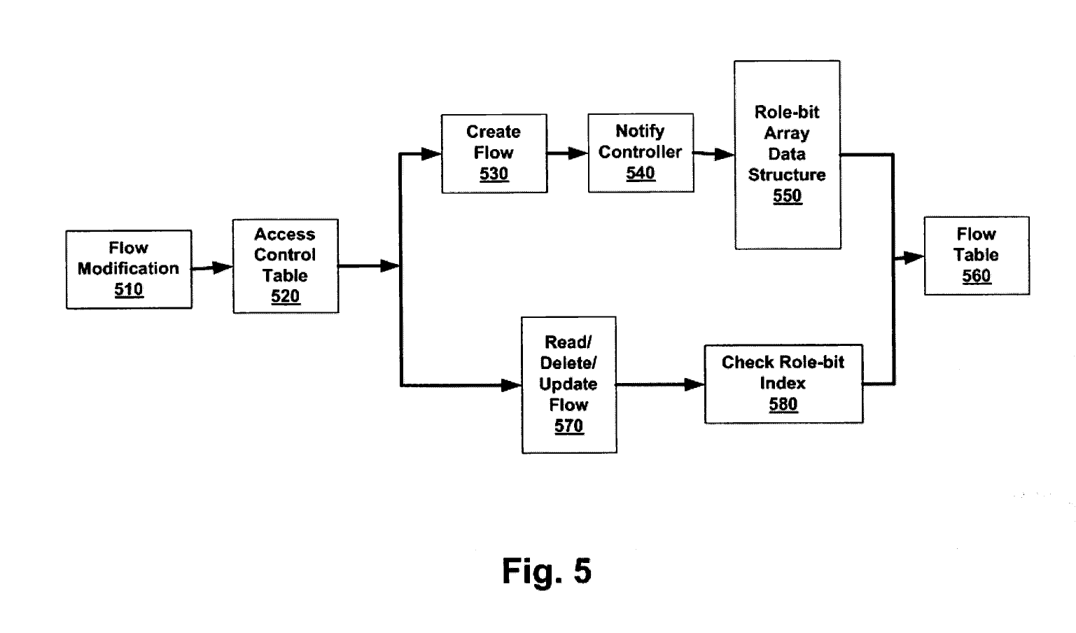

FIG. 5 is a flow chart 500 that illustrates how a new request for a flow modification is processed in step 510. Based on the type of flow modification, the ACT directs the request in one of two directions in step 520. If the request is to create a flow in step 530, the ACT checks if the requested user is an authenticated entity from the ACT, and checks if the permission is set correctly to create the flow. If both checks are positive, the ACT consults the bit-array based FRDS in the controller in step 540, which generates the bit-array based FRDS to update the set of users who will have access to update the flow in step 550. The flow is then pushed to the flow table of the programmable switch in step 560.

If the request is to delete, update, or read an existing flow in step 570, the ACT checks if the requested user is an authenticated entity from the ACT, and checks if the permission is set correctly for a delete, update, or read modification. If both checks are positive, the corresponding role-bit index value is checked for permission to access the flow in step 580. The flow is then sent to the flow table in step 560.

For a delete, update, or read modification in the embodiment described above, the controller plane is not notified of the modification. However, another embodiment includes notifying the controller for any of the four CRUD modifications. The notification to the controller plane for a delete, update, or read modification could occur after each modification, or after a certain period of time or a certain number of modifications. The controller plane could also be scheduled to request a report of the delete, update, and read modifications from each programmable switch.

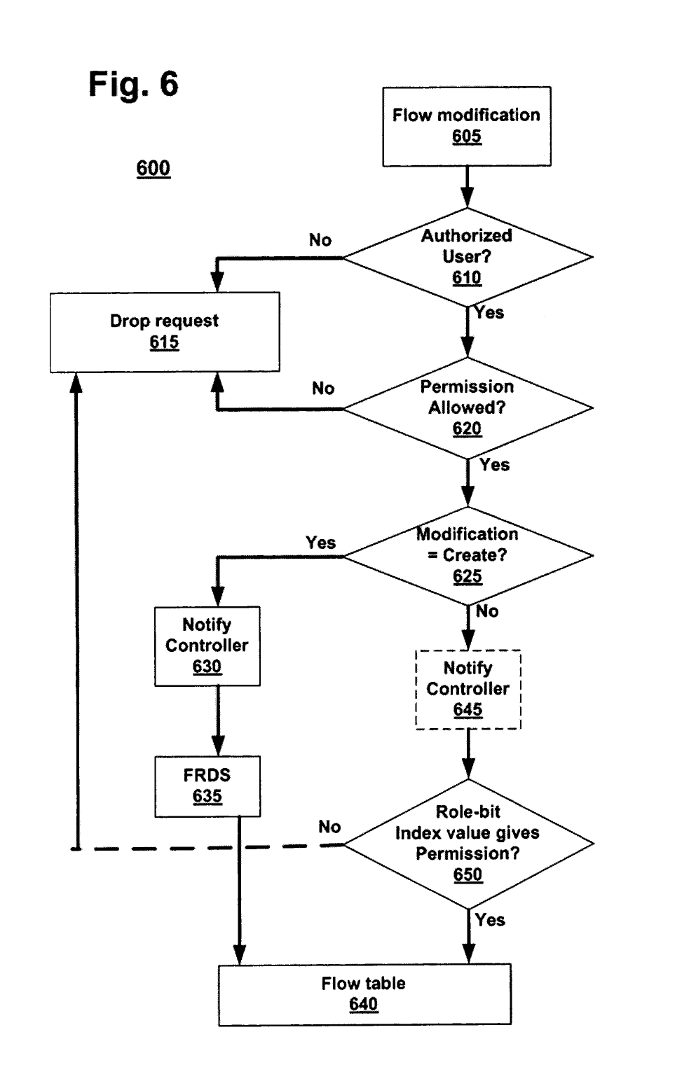

FIG. 6 is a flow chart 600, illustrating an algorithm for tracking a flow modification. A flow modification is received in step 605. The flow modification could be one of a create, read, update, or delete flow modification. It is determined whether the user is an authorized user in step 610. If the user is not authorized, the request is dropped in step 615. In an embodiment, the notifier is configured to notify the controller of an unauthorized request or any other request which is ultimately denied. If the user is authorized, it is determined whether the authorized user has permission to make the flow modification request in step 620. If the authorized user does not have permission, the request is dropped in step 615. If the authorized user has permission to make the request, it is determined whether the request is a create modification in step 625. If the request is for a create flow modification, the controller is notified of the create modification in step 630. The bit-array based FRDS in the controller is notified to update the set of users who will have access to update the flow in step 635. The flow is then pushed to the flow table of the programmable switch in step 640.

If the flow modification in step 625 is not a create modification, i.e. is a read, update, or delete modification, the controller is notified of the modification in alternative step 645. Alternative step 645 is an optional step of notifying the controller, and could occur after each modification, or after a specified time or number of modifications, or the controller could be scheduled to request a report of the modifications. It is determined whether the role-bit index value of the user has permission to access the flow in step 650. If the user's role-bit index value does not have permission, the modification request is dropped in step 615. If the user's role-bit index value does have permission to access the flow, the flow is sent to the flow table in step 640.

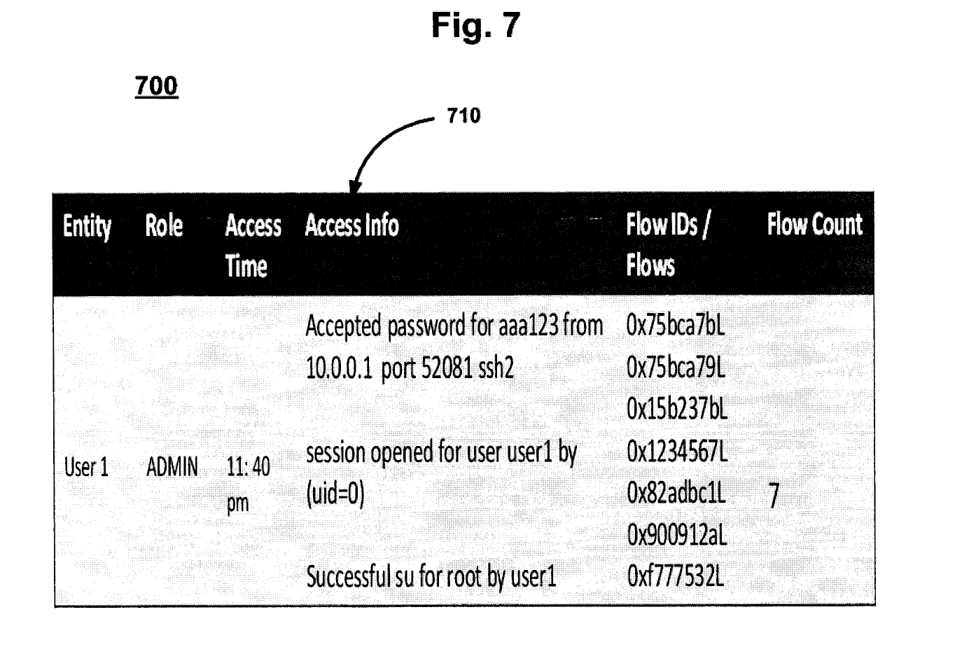

Embodiments described herein provide notification capabilities that allow the programmable switches to notify the controller entity about flow updates or modifications. A notification component (“notifier”) 343 of the component 340 notifies, or causes the programmable switch to notify, the controller entity (controller component 310) of the SDN about a modification request to a flow received from an entity, other than the controller component 310. An embodiment includes receiving a modification request from a side-channel access. The notification to the controller includes, but is not limited to associated authorized login information of the user, the access time, associated access information, the set of flow updates (CRUD), and the flow count. This allows the controller entity to accept or reject the changes made by other users. FIG. 7 illustrates an example of a notification 700 sent to the controller entity. The illustrated access info 710 contains existing information that has been collected from the associated programmable switch.

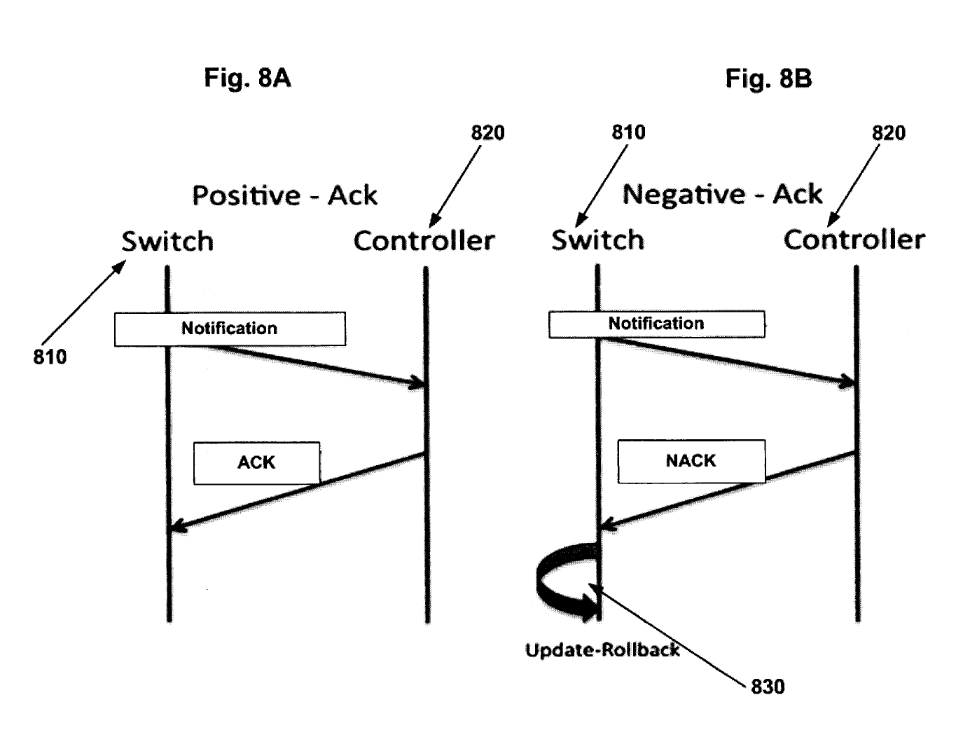

A notification message handshake can be utilized with the controller notifications described above. Both positive and negative acknowledgements to a flow modification are handled by the controller entity. Therefore, consistent updates to the network state are ensured in a SDN architecture. An example of a positive acknowledgement and a negative acknowledgement handshake are illustrated in FIGS. 8A and 8B, respectively. The controller entity has the control of accepting or rejecting the changes after investigating the content of the changes. In FIG. 8A, the notification component causes the switch 810 to send a notification to the controller 820. The controller 820 checks the access table for proper authorization and permission, and sends a positive acknowledgement (ACK) back to the switch 810 if the checks are affirmative. In FIG. 8B, one or more of the checks were not positive, so a negative acknowledgement (NACK) is sent back to the switch 810. The information related to the flow modification is held in a temporary buffer and the state of the switch is rolled back to a previous state (830) until a positive acknowledgement is received. The notification handshake embodiment could be automatic, or it could be made optional and enabled when required by the controller entity.

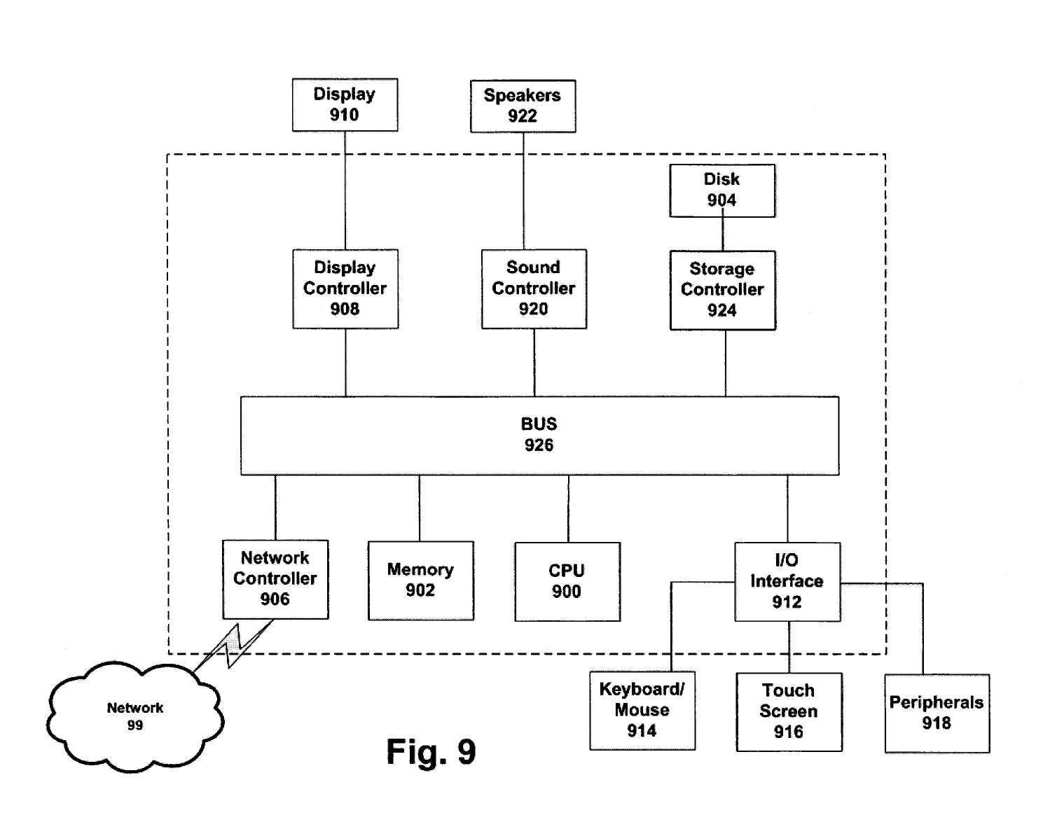

Next, a hardware description of a computing device, used in accordance with exemplary embodiments described herein is described with reference to FIG. 9. In FIG. 9, the computing device includes a CPU 900 which performs the processes described above. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types or circuitry that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The computing device in FIG. 9 also includes a network controller 906, such as an Intel Ethernet PRO network interface card from Intel Corporation of America, for interfacing with network 99. As can be appreciated, the network 99 can be a public network, such as the Internet, or a private network such as an LAN or WAN network, or any combination thereof and can also include PSTN or ISDN sub-networks. The network 99 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the computing device, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the computing device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

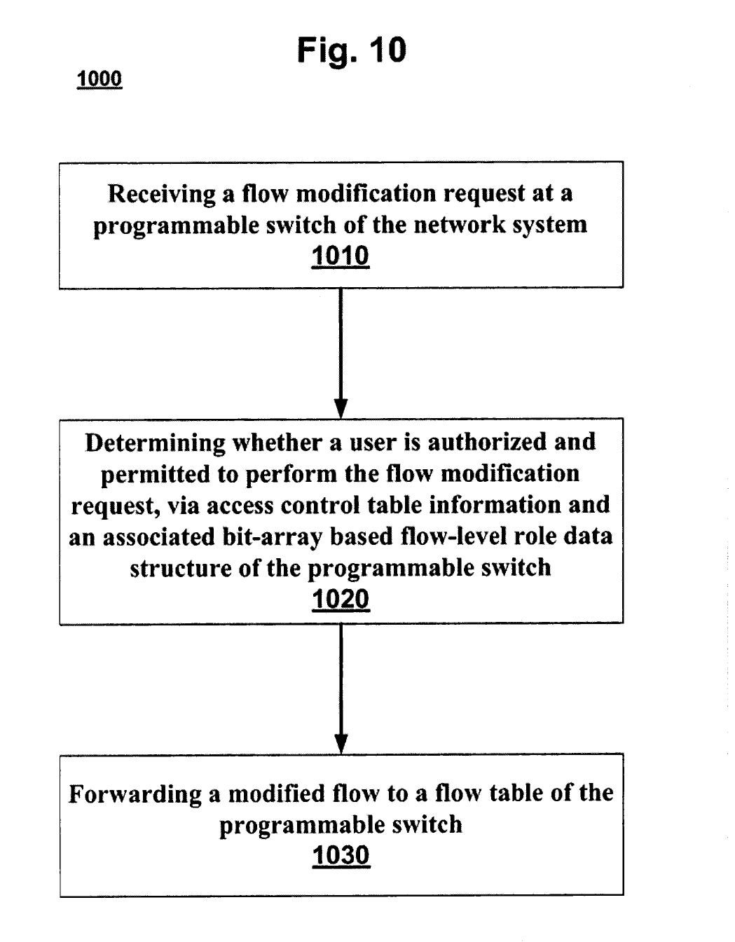

FIG. 10 is a flow diagram, illustrating a method 1000 implemented by a network system, which includes an access controller component and a tracker component. A flow modification request is received at a programmable switch of the network system in step 1010. It is determined whether a user is authorized and permitted to perform the flow modification request in step 1020. The determination is made via access control table information and an associated bit-array based flow-level role data structure of the programmable switch. A modified flow is forwarded to a flow table of the programmable switch in step 1030.

Embodiments of the invention provide systems and methods of access control and tracking capabilities of programmable switches. When any entity other than the controller updates a flow table, embodiments described herein notify the controller about the changes and its associated user information. Any attempts to update non-permissible flow entries will result in triggers and notifications to the controller.

Numerous modifications and variations of the present invention are possible in light of the above teachings. It is therefore to be understood that within the scope of the appended claims, the invention may be practiced otherwise than as specifically described herein.

What is claimed is:

1. A system comprising:
an access controller that stores access control rights of a user to perform an action on a flow table of a programmable switch in a network, wherein the access control rights are determined by stored information that includes a predetermination association of a particular user and a permitted action that the particular user is allowed to take with respect to the flow table; and
a tracker that permits the user to perform an action on the flow table included in a flow modification request received at the programmable switch, based upon the stored access control rights.

2. The system of claim 1, wherein the stored information includes first information, as an access control table, that associates each of a plurality of different users with one or more permitted types of actions that the respective user is allowed to take when the respective user is granted access to take action on a particular flow in the flow table.

3. The system of claim 2, wherein the stored information includes second information, that is separate from the first information, for indicating which of the plurality of different users is granted access to take action on a particular flow in the flow table.

4. The system of claim 3, wherein the second information includes a bit-array based data structure in which each bit position in the data structure provides an indication of whether a respective one of the plurality of different users is granted access to take action on the particular flow in the flow table.

5. The system of claim 4, wherein the access control table indicates a bit position in the data structure that is assigned to each of the plurality of different users.

6. The system of claim 4, wherein a high bit value indicates that the user has access to take action on the particular flow in the flow table, and a low bit value indicates that the user does not have access to take action on the particular flow in the flow table.

7. The system of claim 1, wherein the access control rights that are stored in the access controller are also stored in a separate main controller of the network.

8. The system of claim 1, wherein the flow modification request is a request to create, read, update, or delete a flow.

9. The system of claim 1, further comprising:
a notification component that is configured to control transmission of a notification to a main controller of the network about the flow modification request.

10. The system of claim 9, wherein the notification is sent when the programmable switch is accessed by an entity other than the main controller.

11. The system of claim 9, wherein the notification component receives a positive acknowledgement from the main controller when the main controller has accepted the flow modification request.

12. The system of claim 11, wherein the notification component receives a negative acknowledgement from the main controller when the main controller has not accepted the flow modification request, and information related to the flow modification request is held in a temporary buffer, until a positive acknowledgement is received.

13. The system of claim 9, wherein the notification is sent when the flow modification request is a request to create a flow.

14. The system of claim 9, wherein the notification is sent when the flow modification request is one of a request to read, delete, and update an existing flow,

15. The system of claim 14, wherein the notification is sent according to a number of modifications to an existing flows or after a set period of time.

16. The system of claim 9, wherein the notification component is configured to send a notification to the main controller when the flow modification request is made by an unauthorized user.

17. The system of claim 1, wherein the flow modification request is received via a side-channel access of the programmable switch.

18. The system of claim 1, wherein the access controller and the tracker are embedded in the programmable switch.

19. A method, implemented by a system in a network, the method comprising:
receiving an indication of a flow modification request received at a programmable switch of the network;
determining whether a user is permitted to perform an action on a flow table of the programmable switch that is indicated in the flow modification request, based upon access control rights of a user to perform an action on a flow table of the programmable switch, wherein the access control rights are determined by stored information that includes a predetermination association of a particular user and a permitted action that that the particular user is allowed to take with respect to the flow table.

20. A non-transitory computer-readable medium that stores a program, which when implemented by a computer, causes the computer to perform a method comprising:
receiving an indication of a flow modification request received at a programmable switch of the network;
determining whether a user is permitted to perform an action on a flow table of the programmable switch that is indicated in the flow modification request, based upon access control rights of a user to perform an action on a flow table of the programmable switch, wherein the access control rights are determined by stored information that includes a predetermination association of a particular user and a permitted action that that the particular user is allowed to take with respect to the flow table.
